(19) United States
(12) Patent Application Publication
(10) Pub. No.: US 2020/0240188 A1
(43) Pub. Date: Jul. 30, 2020

(54) Non-Power Driven Window Capable Of Adjusting Ventilation Rate

(71) Applicant: DALIAN UNIVERSITY OF TECHNOLOGY, Dalian City, Liaoning Province (CN)

(72) Inventors: Tengfei ZHANG, Dalian City, Liaoning Province (CN); Facheng LI, Dalian City, Liaoning Province (CN); Yue ZHAO, Dalian City, Liaoning Province (CN); Shugang WANG, Dalian City, Liaoning Province (CN)

(21) Appl. No.: 16/611,724

(22) PCT Filed: May 28, 2018
(86) PCT No.: PCT/CN2018/088688

§ 371 Date: Nov. 7, 2019

(30) Foreign Application Priority Data
Jan. 22, 2018 (CN) 201810057432.4

(51) Int. Cl. E05F 1/00; E05F 5/02; E05F 1/12; E06B 3/40; E06B 7/22; E06B 9/52; E06B 7/06

(52) U.S. Cl. CPC E05F 1/004; E05F 5/02; E05F 1/1207; E06B 3/40; E06B 2009/528; E06B 9/52; E06B 7/06; E06B 2003/403; E05Y 2900/148; E06B 7/22

(57) ABSTRACT

The present invention discloses anon-power driven window capable of adjusting ventilation rate. When the sash is unlocked, due to combined action of the sash's gravitational torque and the expansion of a torsion spring against the sash, the window keeps open. The window is designed having a bigger size in the lower section below the pivot than that in the upper section. Subject to the outdoor wind blowing, the moment by the outdoor wind tends to shut the window. In addition, the upper screen is installed in the outer side of the pane above the pivot, while lower screen is installed to the inner side of the pane below the pivot. Thus the lower sash is exposed into the outdoor air and can be easily blown by the outdoor wind. Consequently, the stronger is the outdoor wind, the smaller is the effective opening of the window for ventilation, and vice versa.

### FIELD OF THE INVENTION

The present invention belongs to the field of building ventilation, in particular relates to a non-power driven window capable of adjusting ventilation rate.

### BACKGROUND

Buildings must be ventilated to dilute the pollutants therein to the specified concentrations. The insufficient outdoor air will lead to excessive indoor pollutant concentrations, which threatens human health and productivity. On the contrary, the excessive ventilation is not acceptable either, because of the increasing burden in building energy consumption. Mechanical ventilation has a good capability to stabilize the building ventilation rate. However, the expense of mechanical ventilation is high and thus is not suitable for wide use. It is necessary to develop a non-power driven ventilation facility to obtain a relatively stable ventilation rate into rooms.

A simple way to maintain the relatively stable ventilation rate is to appropriately control the opening of windows. Published patents and existing products for window opening control adopt manual operation, electrical control, or the feedback control of the outdoor wind pressure. The advantage of manual adjustment is the demand control to satisfy each individual's needs. However, frequent manual intervention may be required. In order to avoid manual intervention, many patents proposed automatic control based on sensors to adjust the opening of the window in real time to maintain a stable indoor ventilation rate. Although the automatic control can accurately adjust the window opening, it is complicated and consumes energy. The reliability and economy of the automatic control based on sensors are not flawless. It is necessary to develop a non-power driven ventilation facility to automatically adjust the indoor ventilation rate.

Till moment, the available non-power driven windows take advantage of the outdoor wind pressure. Most of the windows use springs or ratchets to cause deformation or rotation of ratchets to realize adjustments of window opening sizes. The negative feedback of outdoor wind has not been adopted to adjust the window opening directly. The auxiliary components to control windows are too complex and the big sizes of the auxiliary components may affect visibility of the windows. The present invention proposed a simple horizontally pivoted window, utilizing the compromising action of the gravitational torque and the wind driven torque to directly adjust the opening of the window and stabilize the indoor ventilation rate. The bottom frame of the sash is in the airfoil shape to gain wind pressure for shutting window. A position limiter limits the maximum openable range of the window. The torsion spring and sealing pad on windows reduce shock and noise during closing window when encountering strong winds. The proposed window is simple and reliable, and should be suitable for wide use.

### SUMMARY OF THE INVENTION

The invention proposed a non-power driven window that can automatically adjust the indoor ventilation rate. If the outdoor wind is weak, the window stays at its maximum opening to gain outdoor air into the room as much as possible. If the outdoor wind is strong enough, the window rotates under the action of the wind blowing to the pane on the sash, which reduces the opening size of the window. If the outdoor wind speed is too strong, the window is closed under the action of the wind pressure, and only infiltrated air into rooms is allowed. The above design maintains the room's ventilation rate relatively stable. No power-driven motor is required, nor the monitoring sensor. The proposed window is thus reliable and economical.

The technical solutions of the invention are as follows:

A non-power driven window capable of adjusting ventilation rate, comprises a sash's frame, glass pane, window handle, rotating shaft, position limiter, window frames and sealing structure. The window handle is located at the upper frame of the sash for opening/unlocking or closing/locking the window manually. The rotating shafts are fixed on the left and right sides of the sash's frame, and are located along a coaxial line. The central axis of the rotating shafts are located at the upper part of the sash's frame, so that the area of sash below the rotating shafts is bigger than that above the shafts. The gravitational center of the sash is located above the rotating shafts due to the additional weight of the window handle, the added other weight, or the difference between the density of the glass pane and the sash's frame material. When the window is unlocked for ventilation, because the gravitational center is apart from the rotating shaft, the sash rotates under the action of the gravitational moment. The position limiter is installed within the window frame, and sleeved in outside of rotating shafts. The maximum rotating angle of the sash is thus limited by the position limiter. The window frame is fixed to the wall or an ordinary window, and sealing structure surrounding the window frame is adopted to ensure the air tightness when the window is shut.

More specifically, the above-mentioned position limiter has two different designs, one of which includes limiting ring, limiting nut, adjusting nut and position limiting rod. The position limiting rod is fixed on the adjusting nut, which limits the maximum opening of the sash. The limiting nut is located neighboring to the adjusting nut, and acts as a stopper and ensures that the adjusting nut does not rotate when the limiting nut is not in adjustment. Two nuts are coated in outside of the limiting ring with screw threads. The rotation angle of the limiting ring is controlled by thread matching. The above design can limit the maximum opening of the sash to any desired value. The other design of the position limiter includes a spring, a limiting ring, a position limiting rod, and position limiting spacing piles fixed on the window frame. The position limiting rod is mounted on the limiting ring, multiple position limiting spacing piles are located on the window frame, and a spring is placed in outside of the shaft between the limiting ring and the sash's frame. When the limiting ring is not adjusted, the position limiting rod is located between any of two position limiting spacing piles. By rotating the limiting ring in different piles, the range of maximum rotatable angles can be adjusted. According to the meteorological conditions in different regions and the user's individual demand for indoor ventilation rate, the range of maximum rotatable angles of the sash can be set and selected. The above two designs make the rotating shaft sleeved by the limiting ring.

Further, a position limiter is arranged in outside of the rotating shaft on one side of the window, a fixed ring is arranged in outside of the rotating shaft on the other side. The fixed ring is fixed on the window frame. Torsion springs are set inside the fixed ring and the limiting ring of the position limiter, respectively. One end of the torsion spring is fixed to the inside of the limiting ring or the fixed ring, and the other end is free. Shock reduction is achieved by the contact between the spring arm of the torsion spring and the axial sectional surface of the rotating shaft. The torsion spring inside the fixed ring reduces the shock when the window is shut. When the window tends to be closed, the torsional spring in the fixed ring is in a compressed state, which makes the window reopen automatically when there is no wind or only breezes outside. The torsional spring inside the limiting ring of the position limiter reduces the shock when the window opens to its maximum range.

Further, the bottom frame of the sash is in the airfoil shape to ensure that the sash is subjected to a relatively large wind pressure when the window is opened. Consequently, the wind pressure induces a larger wind pressure moment opposite to the gravitational moment. Hence, the higher is the outdoor wind speed, the smaller is the window opening.

Further, the rotating shafts contact with the limiting ring and the fixed ring against bearings. The friction force between the rotating shafts and the limiting ring or the fixed ring is adjustable by damping of the rotation, which alters frequency of the sash's rotation under transient meteorological conditions.

Further, screens are installed on the upper outdoor side and lower indoor side of the rotating shafts. Due to the increased flow resistance in the upper portion, the wind pressure moment to the lower portion of the window below the rotating shaft is enhanced. Meanwhile, an elastic sealing strip or a sealing screen is arranged on the sash's frame along the axis of the rotating shaft, and is used together with the screen. During rotation of the sash, mosquitoes or insects are prevented from entering the room through the gap between the panes and the screens.

Further, the sealing structure comprises sealing pad in perimeter of the sash, indoor frames, and outdoor frames, to ensure sealing and positioning when the sash is shut. The sash has peripheral frames that can be mounted anywhere within any form of windows.

### Beneficial Effects of the Present Invention

1. The proposed non-power window can automatically adjust the opening of the window according to the outdoor wind speed, so as to maintain relatively stable outdoor air rate into rooms. When there is no wind or just having breeze outside, the window resides at the maximum opening; when the outdoor wind speed increases, the window rotates due to the action of the outdoor wind pressure to the panes, and then the opening of the window decreases; when the outdoor wind speed is too high, the window is shut under the action of a very large wind pressure moment. No power or sensor is required to adjust the opening of the window, and thus there is no direct energy consumption by the window.

2. Different maximum openings of the window can be set by users. The maximum opening of the window can be set according to the meteorological wind speed in different areas and the user's individual demand of outdoor air rate.

3. Screens are installed along the window. When the outdoor wind blows the windows, the lower part of the sash is under the direct action of the wind pressure because the lower screen is located in the inner side. However, the upper screen is located in the outer side, which slows down the wind blowing to the upper sash. Such design also facilitates shutting of the window subject to the window blowing. Mosquitoes or insects can be prevented from entering the room because of the installed screens.

4. The bottom frame of the sash is in the airfoil shape. The airfoil can gain wind pressure action and aids shutting the window under strong winds.

5. The torsion spring and sealing pad reduce the shock when the window closes, which avoids damage to the panes and frames and also reduces the noise of shutting the window or limiting the window to its maximum opening range. When there is no wind or just having breezes outside, the torsion spring can automatically reopen the window if the window is unlocked. The rotating shaft has a damper, which can adjust the friction force for rotating the sash and the frequency of the window's rotation.

6. The rotatable window has rectangular outer frame, which can be easily installed within an ordinary window. The proposed rotatable window is simple and reliable, and should be suitable for wide use in different climatic zones.

### DESCRIPTION OF DRAWINGS

FIG. 1 is an overall schematic view of the non-power driven window capable of adjusting ventilation rate.

FIG. 2 is a schematic view of the opened non-power driven window capable of adjusting ventilation rate: (a) overall view, (b) side view.

FIG. 3 is a diagram of the closed non-power driven window capable of adjusting ventilation rate: (a) overall view, (b) side view.

FIG. 4 is the front view of the outdoor appearance of the non-power driven window capable of adjusting ventilation rate.

FIG. 5 is a schematic view of the position limiter on the right hand side of the non-power driven window capable of adjusting ventilation rate.

FIG. 6 is an overall schematic view of the indoor appearance of the non-power driven window capable of adjusting ventilation rate.

FIG. 7 is a schematic view of the left rotation axis and the shock damping structure of the non-power driven window capable of adjusting ventilation rate: (a) when the window is opened, (b) when the window is closed.

FIG. 8 is a schematic view of the right rotation axis of the non-power driven window capable of adjusting ventilation rate; (a) when the window is opened, (b) when the window is opened to the maximum opening range.

FIG. 9 is a schematic view of the indoor of the whole window including the closed rotatable window.

FIG. 10 is a schematic view of the indoor of the whole window including the opened rotatable window.

FIG. 11 is a schematic view of the outdoor of the whole window including the opened rotatable window.

In the above figures: 1 sash's frame; 2 glass pane; 3 window handle; 4 exterior door on window frame; 5 right frame of the window; 6 upper frame of the window; 7 screen; 8 left frame of the window; 9 bottom window frame; 10 rotating shaft A; 11 limiting ring; 12 sealing pad; 13 lower frame; 14 upper frame; 15 bottom frame of the sash in the airfoil shape; 16 elastic sealing strip; 17 position limiting spacing pile; 18 spring; 19 rotating shaft B; 20 torsion spring A; 21 fixed ring; 22 torsion spring B; 23 ordinary mother window to mount the proposed rotatable window; 24 position limiting rod.

### DETAILED DESCRIPTION

The invention will be described in detail in conjunction with the drawings and specific embodiments.

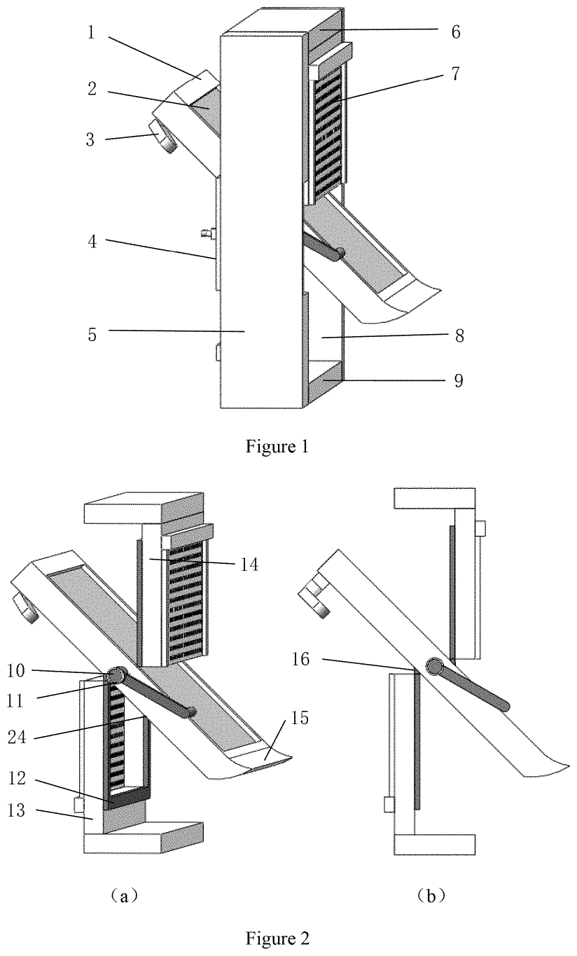

FIG. 1 is an overall schematic view of the non-power window capable of adjusting ventilation rate. It contains sash's frame 1, glass pane 2, window handle 3, screen 7, position limiter to limit sash's rotation, seals, shock damper and window frames. The window handle 3 is installed on the sash's frame 1, which can be used to manually open or close the window. The screen 7 is mounted on the upper outdoor side and lower indoor side of the rotating shaft of the window. The screen 7 allows the window to be used in night to prevent mosquitoes or insects entering the room. The position limiter for window rotation is installed on the right side of the window frame, and the position limiter is adjustable after opening the exterior door on window frame 4.

FIG. 2 is a schematic view of the non-power window capable of adjusting ventilation rate at its opening status. The rotating shaft A 10 is wholly connected with the sash's frame 1, and can rotate together with the sash's frame 1. The rotating shafts are fixed on the left and right sides of the sash's frame, and are located along a coaxial line. The rotating shafts are located at the upper part of the sash's frame, and consequently the area of sash below the rotating shafts is bigger than that above the shafts. The gravitational center of the sash is located above the rotating shafts by the additional weight of the window handle 3, the added weight, or the difference between the density of the glass pane 2 and the sash's frame 1 material. Limiting ring 11 is not in contact with the sash's frame 1, and is sleeved in outside of rotating shaft A 10 so that the rotating shaft A 10 can be rotated inside the limiting ring. The position limiting rod 24 on the limit ring 11 is used to limit the maximum openable range of the window.

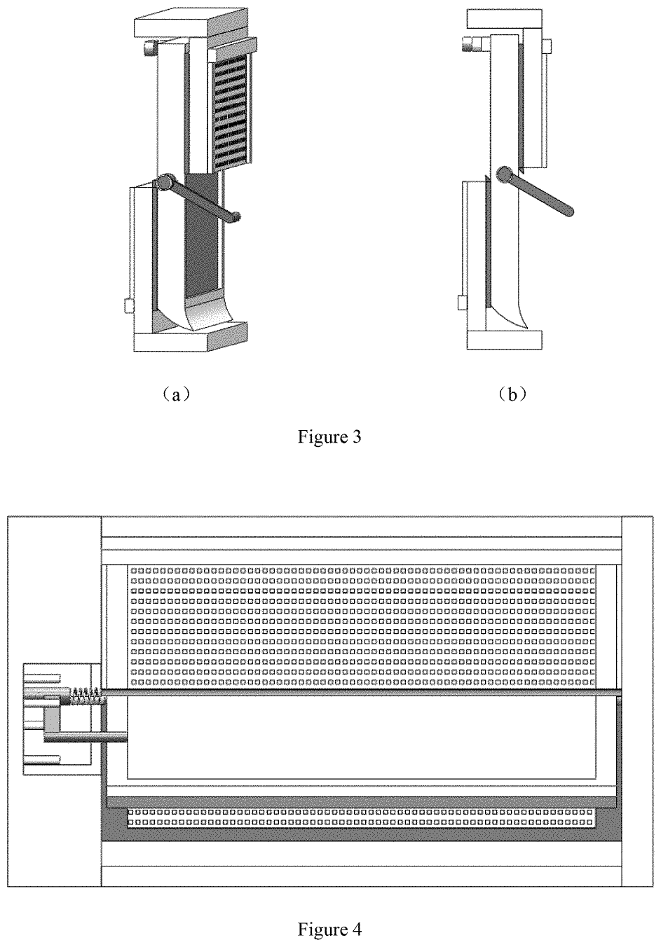

When the window is opened by turning window handle 3, due to the action of the gravitational moment and the limitation of the position limiting rod 24, the window can naturally rotate to its maximum opening as shown in FIG. 2 (b). As shown in FIG. 2 (a), outdoor air can enter the room through the upper and lower openings of the window. When the outdoor wind speed increases, the window rotates under the force exerted by the outdoor wind pressure to reduce the opening of the window. Since the rotating shaft A 10 is located at the upper section of the sash, the outdoor wind acts on the lower portion of the window with a larger area than the upper portion. Meanwhile, because the screen 7 is installed in the upper side of the rotating shaft A 10, the flow resistance for the incoming air is increased. Moreover, bottom frame of the sash in the airfoil shape 15 is designed at the bottom of the window to ensure that the lower portion of the window gains a relatively large wind pressure when the window is opened. The wind pressure moment opposite to the gravitational moment is generated under the action of the outdoor wind. The above three designs ensure that the lower portion of window is subjected to a more intensive wind blowing action, which facilitates closing of the window. When the outdoor wind speed is too high, the window is closed under the action of the wind pressure moment and does not ventilate the room, as shown in FIG. 3. The sealing pad 12, the lower frame 13, the upper frame 14, and the elastic sealing strip 16 are installed around the window, which can ensure that the window has good sealing performance when it rotates and closes.

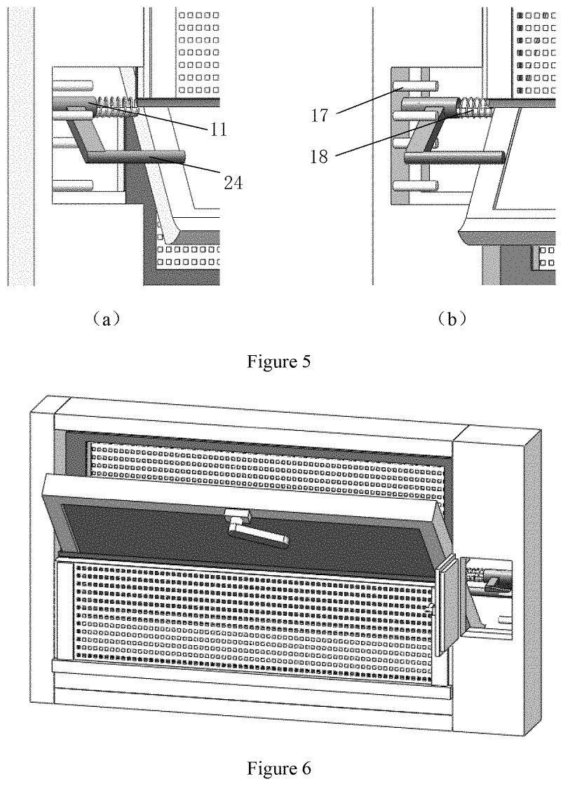

FIG. 4 is a front view of the outdoor appearance of the non-power driven window capable of adjusting ventilation rate, where the position limiter is magnified. FIG. 5 is a schematic view of the position limiter on the right hand side of the non-power driven window capable of adjusting ventilation rate. As shown in the figures, the position limiting rod 24 hinders the rotation of the sash until to the maximum opening of the window. Two adjacent position limiting spacing piles 17 can limit the rotation of the position limiting rod 24 to some specific ranges and control the maximum opening of the window according to the pile positions. A plurality of position limiting spacing piles 17 are provided to limit the position limiting rod 24 to various angles, thereby adjusting the maximum opening of the window according to the meteorological wind speed in different areas and the different user demands for ventilation rate. The position limiting spacing pile 17 is installed on the right frame of the window 5. The spring 18 is set between the limiting ring 11 and the sash's frame 1, which ensures that the position limiting rod is located between the two limiting piles when the limiting ring is not in adjustment.

FIG. 6 is the overall schematic view of the indoor appearance of the non-power driven window capable of adjusting ventilation rate. The exterior door on the window frame 4 can be opened indoors, so that the user can control the limiting ring 11 to adjust the ventilation range.

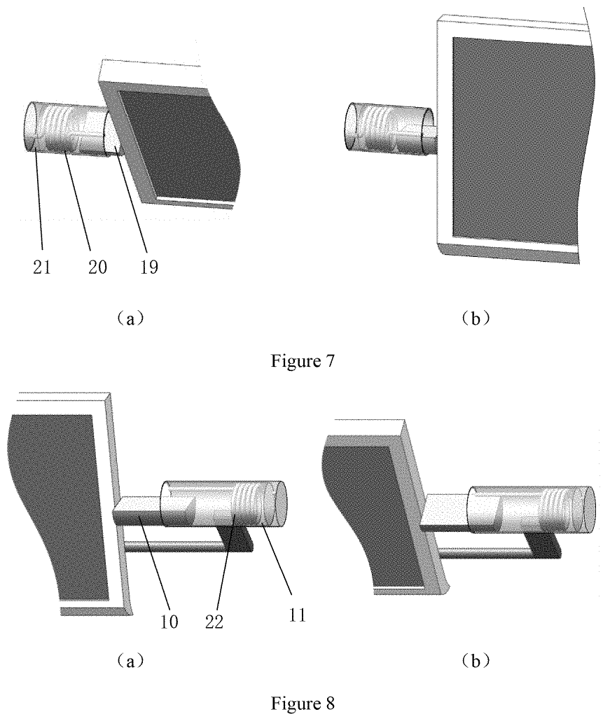

FIG. 7 is a schematic view of the left shock damper of the non-power driven window capable of adjusting ventilation rate. A fixed ring 21 is installed in outside of the rotating shaft B 19 on the left side of the window, and is mounted on the left frame of the window 8. A torsion spring A 20 is arranged inside the fixed ring 11. One end of the torsion spring A 20 is fixed on the fixed ring, and the other end is used to reduce the shock and noise when the window is closed. As shown in FIG. 7 (a), when the window is opened, the torsion spring A 20 is in a natural state. When the window rotates under the action of outdoor wind, the rotating shaft B 19 will touch the spring arm of the torsion spring first, reducing the shock noise when closing the window. Meanwhile, as shown in FIG. 7 (b), the torsion spring A 19 is in a compressed state when the window is closed. If there is no wind or having only breeze outside, both the torsion spring A 19 and the gravitational torque make the window reopen.

FIG. 8 is a schematic view of the shock damper on the right side of the non-power driven window capable of adjusting ventilation rate. A limiting ring 11 is set in outside of the right rotating shaft A 10. Similar to the shock damper in the left side of the window, a torsion spring B 22 is set inside the limiting ring 11. One side of the torsion spring B 22 is fixed, on the limiting ring 11, and the other side reduces the shock when the window reaches its maximum opening. As shown in FIG. 8 (a), the spring arm does not touch the rotating shaft A 10 when the window is opened. However, when the window is close to its maximum openable range, as shown in FIG. 8 (b), the rotating shaft A 10 touches the spring arm, which buffers the sash's frame from hitting the position limiting rod 24 heavily.

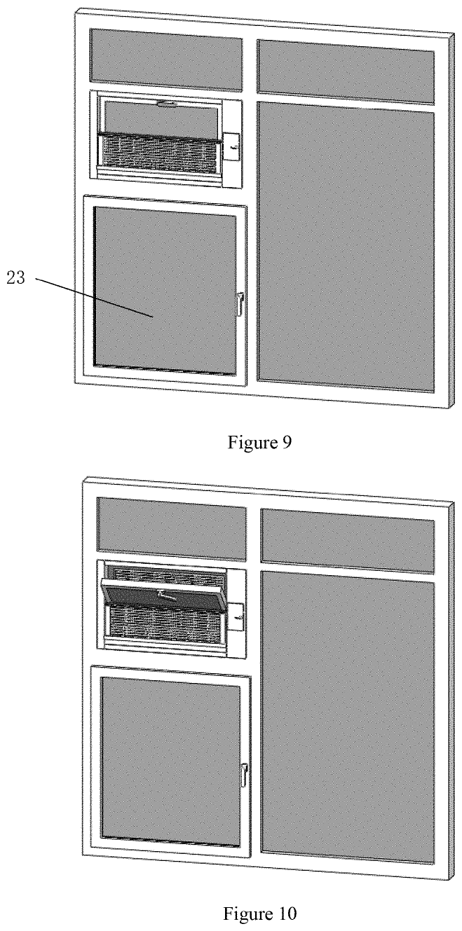

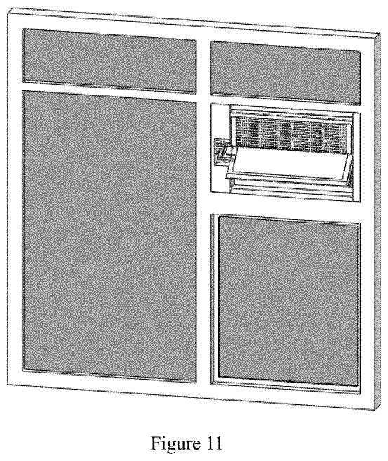

FIGS. 9 and 10 are the overall schematic views of indoor side of the closed and opened rotatable window within an ordinary window based on the indoor view. FIG. 11 is the overall schematic view of outdoor side of the opened rotatable window within an ordinary window. As shown in the figures, the rotatable window is mounted to the upper portion of the ordinary mother window to mount the proposed rotatable window 23. The window handle 3 of the window control the opening or closing of the window. If much more outdoor air is needed in the room, the manual opening of the ordinary mother window to mount the proposed rotatable window 23 can be operated.

1. A non-power driven window capable of adjusting ventilation rate, wherein comprising a sash's frame, glass pane, window handle, rotating shaft, position limiter, window frames and sealing structure; the window handle is located at the upper frame of the sash for opening or closing the window manually; the rotating shafts are fixed on the left and right sides of the sash's frame, and are located along a coaxial line; the central axis of rotating shafts are located at the upper part of the sash's frame, so that the area of sash below the rotating shafts is bigger than that above the shafts; the gravitational center of the sash is located above the rotating shafts by the additional weight of the window handle, the added weight or the difference between the density of the glass pane and the sash's frame material; when the window is unlocked for ventilation, because the gravitational center is apart from the rotating shaft, the sash rotates under the action of the gravitational moment; the position limiter is installed within the window frame, in outside of rotating shafts; the maximum rotating angle of the sash is thus limited by the position limiter; the window frame is fixed to the wall or an ordinary window, and sealing structure in perimeter of the window frame is adopted to ensure the air tightness when the window is shut.

2. The non-power driven window capable of adjusting ventilation rate according to claim 1, wherein the position limiter has two designs, one of which includes limiting ring, limiting nut, adjusting nut and position limiting rod; the position limiting rod is fixed on the adjusting nut, the limiting nut is located neighboring to the adjusting nut, the limiting nut and the adjusting nut are coated in outside of the limiting ring with screw threads; the rotation angle of the limiting ring is controlled by thread matching; the other design of the position limiter includes a spring, a limiting ring, a position limiting rod, and position limiting spacing piles fixed on the window frame; the position limiting rod is mounted on the limiting ring, multiple position limiting spacing piles are located on the window frame, and the spring is placed in outside of the shaft between the limiting ring and the sash's frame; when the limiting ring is not adjusted, the position limiting rod is located between any of two position limiting spacing piles; the above two designs make the rotating shaft sleeved by the limiting ring.

3. The non-power driven window capable of adjusting ventilation rate according to claim 1, wherein a position limiter is arranged in outside of the rotating shaft on one side of the window, a fixed ring is arranged in outside of the rotating shaft on the other side; the fixed ring is fixed on the window frame; torsion springs are set inside the fixed ring and the limiting ring of the position limiter, respectively; one end of the torsion spring is fixed to the inside of the limiting ring or the fixed ring, and the other end is free; shock reduction is achieved by the contact between the spring arm of the torsion spring and the axial sectional surface of the rotating shaft.

4. The non-power driven window capable of adjusting ventilation rate according to claim 1, wherein the bottom frame of the sash is in the airfoil shape to ensure that it gains a relatively large wind pressure when the window is opened, and a larger wind pressure moment opposite to the gravitational moment under the action of the outdoor wind is generated.

5. The non-power driven window capable of adjusting ventilation rate according to claim 3, wherein the bottom frame of the sash is in the airfoil shape to ensure that it gains a relatively large wind pressure when the window is opened, and a larger wind pressure moment opposite to the gravitational moment under the action of the outdoor wind is generated.

6. The non-power driven window capable of adjusting ventilation rate according to claim 3, wherein the rotating shafts contact with the limiting ring and the fixed ring against bearing; the friction force between the rotating shafts and the limiting ring or the fixed ring is adjustable by damping of the rotation, which alters frequency of the sash's rotation under transient meteorological conditions.

7. The non-power driven window capable of adjusting ventilation rate according to claim 5, wherein the rotating shafts contact with the limiting ring and the fixed ring against bearing; the friction force between the rotating shafts and the limiting ring or the fixed ring is adjustable by damping of the rotation, which alters frequency of the sash's rotation under transient meteorological conditions.

8. The non-power driven window capable of adjusting ventilation rate according to claim 1, the upper outer side and the lower inner side of the rotating shaft are equipped with screens; meanwhile, an elastic sealing strip or a sealing screen is arranged on the sash's frame along the axis of the rotating shaft, and is used together with the screen.

9. The non-power driven window capable of adjusting ventilation rate according to claim 3, the upper outer side and the lower inner side of the rotating shaft are equipped with screens; meanwhile, an elastic sealing strip or a sealing screen is arranged on the sash's frame along the axis of the rotating shaft, and is used together with the screen.

10. The non-power driven window capable of adjusting ventilation rate according to claim 4, the upper outer side and the lower inner side of the rotating shaft are equipped with screens; meanwhile, an elastic sealing strip or a sealing screen is arranged on the sash's frame along the axis of the rotating shaft, and is used together with the screen.
